(19) United States
(12) Patent Application Publication
(10) Pub. No.: US 2006/0171532 A1
(43) Pub. Date: Aug. 3, 2006

(54) Encryption Processing Circuit

(75) Inventors: Akira Iketani, Gunma-ken (JP); Shizuka Ishimura, Gunma-ken (JP); Kazumasa Chigira, Gunma-ken (JP)

Correspondence Address: FISH & RICHARDSON P.C., P.O. BOX 1022, MINNEAPOLIS, MN, 55440-1022, US

(73) Assignee: SANYO ELECTRIC CO., LTD, Osaka (JP)

(21) Appl. No.: 11/275,880

(22) Filed: Feb. 1, 2006

(30) Foreign Application Priority Data
Feb. 3, 2005 (JP) 2005028115
Feb. 3, 2005 (JP) 2005028116

(51) Int. Cl. H04L 9/28

(52) U.S. Cl. 380/28

(57) ABSTRACT

An encryption processing circuit which performs a permutation process of a common key block encryption system that permutes input data of plural bits according to a per-bit correspondence rule and outputs the processed data. The encryption processing circuit comprises a data input unit that receives the input data of plural bits, the data input unit having an output port that outputs the received input data of plural bits in parallel; a data output unit that has an input port to which data of plural bits is input in parallel, the data output unit outputting the data of plural bits inputted to the input port; and a permuting unit that connects the output port and the input port according to the per-bit correspondence rule.

### CROSS-REFERENCE TO RELATED APPLICATIONS

The present application claims priority from Japanese Patent Application No. 2005-28115 and Japanese Patent Application No. 2005-28116 filed on Feb. 3, 2005, which are herein incorporated by reference.

### BACKGROUND OF THE INVENTION

1. Field of the Invention

The invention relates to an encryption processing circuit for use in a common key block encryption system.

2. Description of the Related Art

In these years, as in a keyless entry system, transmission and reception of data are performed popularly by a communication means such as a radio transmission means. In the case of the keyless entry system, data is transmitted and received after being encrypted such that the data is not decrypted illegally by a third party.

Although various data encryption systems exist, it is desired to use standard specifications such as the DES (Data Encryption Standard) and the AES (Advanced Encryption Standard). This is because a risk of illegal decryption can be calculated easily and a premium for illegal decryption insurance can be calculated based on the risk for these standard encryption systems. On the other hand, when using an encryption system other than the standard specifications, such as a proprietary specification, it is difficult to calculate the risk of illegal decryption and the insurance premium increases in general.

In these common key block encryption system such as the DES or AES, data are divided into several blocks and processing such as permutation or substitution is performed for each block. The permutation or substitution processing can be performed by storing a correspondence table showing correspondence between input data and output data into a memory and obtaining output data corresponding to given input data based on the correspondence table (see, e.g., Japanese Patent Application Laid-Open Publication No. 2004-120307).

However, where implementing permutation or substitution with software, since the correspondence table stored in a memory is repeatedly referred to, processing load and power consumption are large. Hence, when a keyless entry system employs a common key block encryption system that implements permutation or substitution with software, it is problematic that a battery is rapidly exhausted in a child device that is operated by a user for locking/releasing. In the keyless entry system, processing speed of encryption and decryption must be improved to achieve better response to an operation such as locking/releasing.

### SUMMARY OF THE INVENTION

The present invention was conceived in consideration of the above problems, and it is therefore an object of the present invention to provide an encryption processing circuit that performs encryption and decryption processes in the common key block encryption system with low power consumption and at high speed.

In order to achieve the above and other objects, according to an aspect of the present invention there is provided an encryption processing circuit which performs a permutation process of a common key block encryption system that permutes input data of plural bits according to a per-bit correspondence rule and outputs the processed data. The processing circuit comprises a data input unit that receives the input data of plural bits, the data input unit having an output port that outputs the received input data of plural bits in parallel; a data output unit that has an input port to which data of plural bits is input in parallel, the data output unit outputting the data of plural bits inputted to the input port; and a permuting unit that connects the output port and the input port according to the per-bit correspondence rule.

According to another aspect of the present invention there is provided an encryption processing circuit which performs a substitution process of a common key block encryption system that converts input data of plural bits according to a correspondence rule and outputs the processed data. The processing circuit comprises a data input unit that receives the input data of plural bits, the data input unit having an output port that outputs the received input data of plural bits in parallel; a substituting unit that is a logical circuit which converts the input data of plural bits output in parallel from the data input unit according to the correspondence rule and outputs; and a data output unit that has an input port to which data of plural bits output from the substituting unit is input in parallel, the data output unit outputting the data of plural bits input to the input port.

According to yet another aspect of the present invention there is provided an encryption processing circuit which performs a substitution process of a common key block encryption system that converts input data of plural bits and outputs the processed data. The encryption processing circuit is a logical circuit that receives the input data and selection data instructing to permute the input data and permutes the input data according to the selection data and then converts the permuted input data according to a predetermined correspondence rule and outputs.

With the encryption processing circuit performing the substitution process of a common key block encryption system, security can thus be enhanced since a correspondence rule between input data and output data in the substitution process is made variable without modifying hardware.

### BRIEF DESCRIPTION OF DRAWINGS

The above and other objects, aspects, features and advantages of the present invention will become more apparent from the following detailed description when taken in conjunction with the accompanying drawings, in which:

FIG. 1 is a diagram showing the overall configuration of a keyless entry system for locking/releasing a lock of a vehicle, which is an implementation using an encryption processing circuit of the present invention;

FIG. 2 is a diagram showing the configuration of the data processing circuit;

FIG. 3 is a flowchart showing a communication procedure between a child device and a parent device of the keyless entry system;

FIG. 4 is a flowchart showing the flow of a DES encryption process;

FIG. 5 is a diagram showing the process flow of an F-function (F(R, K));

FIG. 6 is a flowchart showing the flow of a DES decryption process;

FIG. 7 is a diagram showing the configuration of the encryption processing circuit;

FIG. 8 is a diagram showing a per-bit correspondence rule for initial permutation;

FIG. 9 is a diagram showing the configuration of an initial permuting unit;

FIG. 10 is a diagram showing a per-bit correspondence rule for inverse initial permutation;

FIG. 11 is a diagram showing the configuration of an inverse initial permuting unit;

FIG. 12 is a diagram showing a per-bit correspondence rule for expansion permutation;

FIG. 13 is a diagram showing the configuration of an expansion permuting unit;

FIG. 14 is a diagram showing the configuration of an S-BOX unit;

FIG. 15 is a diagram showing a correspondence rule for an S-BOX (S1);

FIG. 16 is a diagram showing the configuration of the S1 of the S-BOX unit;

FIG. 17 is a diagram showing a per-bit correspondence rule for P-permutation;

FIG. 18 is a diagram showing the configuration of a P-permuting unit;

FIG. 19 is a diagram showing a per-bit correspondence rule for PC1 permutation;

FIG. 20 is a diagram showing the configuration of a PC1 permuting unit;

FIG. 21 is a diagram showing the number of rotations in the rotational shift;

FIG. 22 is a diagram showing the configuration of a rotational shift unit;

FIG. 23 is a diagram showing a per-bit correspondence rule for PC2 permutation; and

FIG. 24 is a diagram showing the configuration of a PC2 permuting unit.

### DETAILED DESCRIPTION OF THE INVENTION

At least the following matters will be made clear by the explanation in the present specification and the description of the accompanying drawings.

==Overall Configuration==

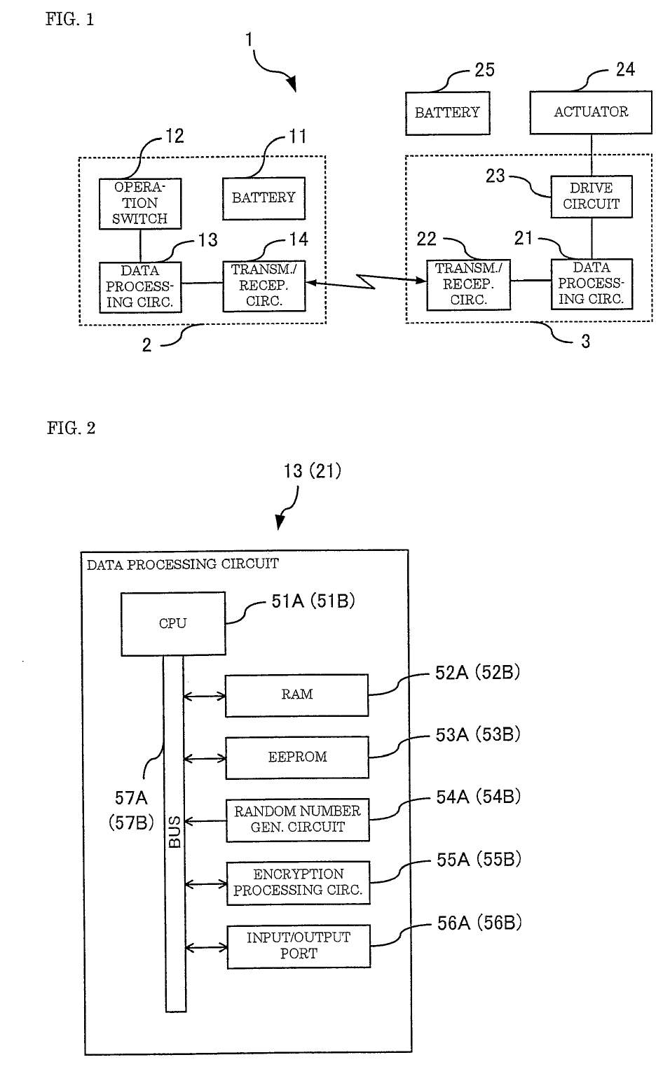

FIG. 1 is a diagram showing the overall configuration of a keyless entry system 1 for locking/releasing a lock of a vehicle, which is an implementation using an encryption processing circuit of the present invention. The keyless entry system 1 is constituted to include a portable child device 2 and a parent device 3 mounted in a vehicle, etc. The child device 2 is installed in a handle portion, etc., of a key that is inserted into a key hole of a door lock or a steering lock of a vehicle, for example. The parent device 3 is installed in the vehicle.

The child device 2 is provided with a battery 11, an operation switch 12, a data processing circuit 13, and a transmission/reception circuit 14. The battery 11 is for the purpose of supplying electric power necessary for operation of each unit of the child device 2. The operation switch 12 is a switch for accepting a lock/release instruction from a user. The data processing circuit 13 performs generation of authentication data necessary for locking/releasing, etc. The transmission/reception circuit 14 is a circuit for converting digital data output from the data processing circuit 13 into analog data, and amplifying and sending the analog data as electromagnetic waves. The transmission/reception circuit 14 can also receive and convert electromagnetic waves sent out from the parent device 3 into digital data, and input to the data processing circuit 13. As the electromagnetic waves, electric waves or infrared rays are used.

The parent device 3 is provided with a data processing circuit 21, a transmission/reception circuit 22, and a drive circuit 23. The data processing circuit 21 performs authentication processing based on the authentication data received from the child device 2, etc. The transmission/reception circuit 22 is a circuit that receives and converts electromagnetic waves output from the child device 2 into digital data and that inputs to the data processing circuit 21. The transmission/reception circuit 22 can also convert digital data output from the data processing circuit 21 into analog data, and amplify and send as electromagnetic waves. The drive circuit 23 is a circuit that transmits a drive signal to an actuator 24 to actuate a lock mechanism that locks/releases a lock of a vehicle. Each unit 21 to 23 of the parent device 3 is supplied with electric power from a battery 25 of the vehicle.

==Configuration of Data Processing Circuit==

FIG. 2 is a diagram showing the configuration of the data processing circuit 13. The data processing circuit 13 is provided with a CPU 51A, a RAM (Random Access Memory) 52A, an EEPROM (Electrically Erasable Programmable Read-Only Memory) 53A, a random number generator 54A, an encryption processing circuit 55A, and an input/output port 56A. The units 51A to 56A are connected via a bus 57A to be able to communicate with each other.

The CPU 51A controls the data processing circuit 13 as a whole. The RAM 52A stores working data, etc., to be used by the CPU 51A. The EEPROM 53A is a rewritable nonvolatile memory and stores programs, data subject to being saved, etc. The random number generator 54A is a circuit that generates pseudo random numbers or physical random numbers that are used in encryption processing. The encryption processing circuit 55A is a circuit that performs processing such as permutation or substitution in a common key block encryption system. The input/output port 56A is an interface that transmits/receives data to/from the operation switch 12, the transmission/reception circuit 14, etc., outside the data processing circuit 13.

In the implementation, the DES (Data Encryption Standard) is used as a common key block encryption system. In this data processing circuit 13, DES encryption or decryption is performed by executing a program and controlling the encryption processing circuit 55A, etc. The data processing circuit 21 has the same configuration and is provided with a CPU 51B, a RAM 52B, an EEPROM 53B, a random number generator 54B, an encryption processing circuit 55B, an input/output port 56B, and a bus 57B connecting the units 51B to 56B to be able to communicate with each other.

==Communication Procedure==

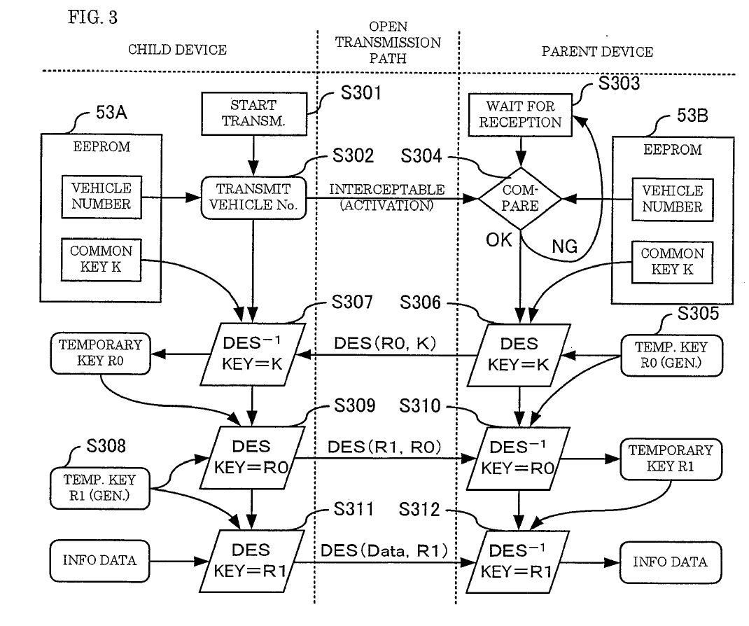

FIG. 3 is a flowchart showing a communication procedure between the child device 2 and the parent device 3 of the keyless entry system 1. Transmission processing is activated, for example, by operation of the operation switch 12 of the child device 2 (S301). The data processing circuit 13 of the child device 2 transmits a vehicle number (vehicle identification number) stored in the EEPROM 53A to the parent device 3 (S302). The data processing circuit 21 of the parent device 3 waits for the vehicle number to come in from the child device 2 (S303) and compares the vehicle number with a vehicle number stored in the EEPROM 53B when receiving the vehicle number transmitted from the child device 2 (S304).

If the vehicle numbers are not identical (S304: NG), the data processing circuit 21 of the parent device 3 determines that the vehicle number of another vehicle is transmitted and returns to the reception waiting process(S303). If the vehicle numbers are identical (S304: OK), the data processing circuit 21 uses the random number generator 54B to generate a 64-bit temporary key R0 (S305). The data processing circuit 21 encrypts this temporary key R0 according to the DES with a common key K stored in the EEPROM 53B and transmits to the child device 2 (S306).

When receiving the encrypted temporary key R0 transmitted from the parent device 3, the data processing circuit 13 of the child device 2 decrypts the temporary key R0 with a common key K stored in the EEPROM 53A (S307). The data processing circuit 13 uses the random number generator 54A to generate a 64-bit temporary key R1 (S308). The data processing circuit 13 encrypts this temporary key R1 according to the DES with the temporary key R0 received from the parent device 3 and transmits to the parent device 3 (S309). When receiving the encrypted temporary key R1 transmitted from the child device 2, the data processing circuit 21 of the parent device 3 decrypts the temporary key R1 with the temporary key R0 (S310).

The data processing circuit 13 of the child device 2 then encrypts information data such as a lock/release instruction according to the DES with the temporary key R1 and transmits to the parent device 3 (S311). When receiving the encrypted information data transmitted from the child device 2, the data processing circuit 21 of the parent device 3 decrypts the information data with the temporary key R1 (S312). Based on the information data, the data processing circuit 21 transmits a lock/release instruction signal to the actuator 24 via the drive circuit 23, for example.

In this way, in the keyless entry system 1, the child device 2 and the parent device 3 use the random number generators 54A, 54B to generate the temporary keys and perform the DES encryption and decryption processing repeatedly to enhance the security strength.

==DES Encryption and Decryption Processing==

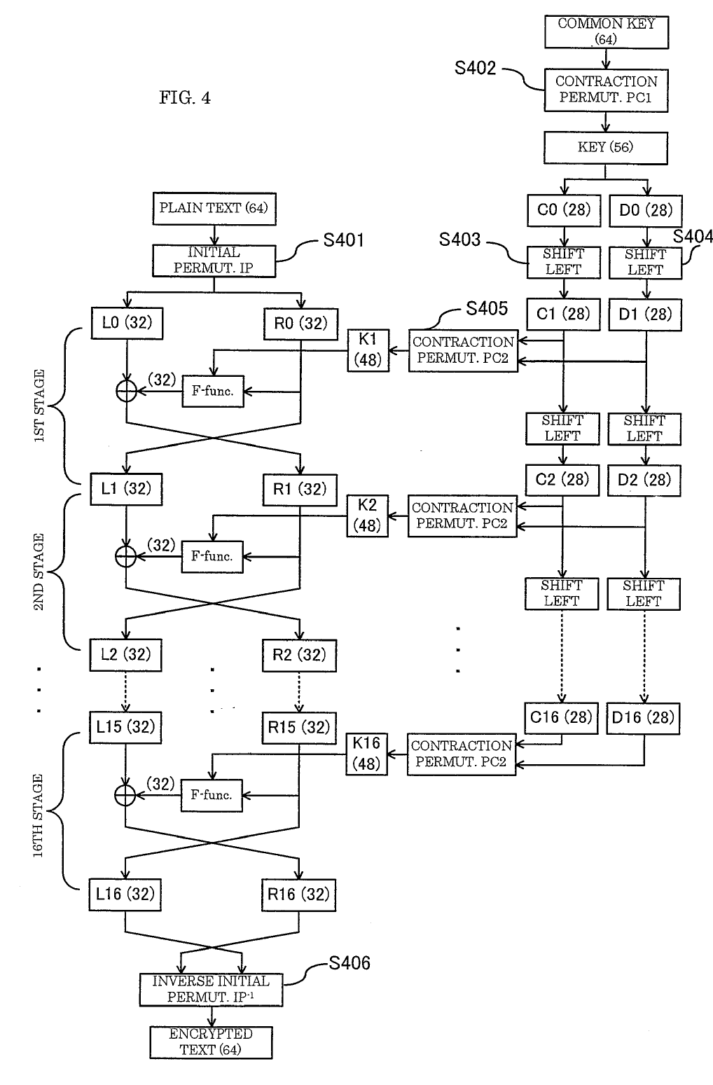

FIG. 4 is a flowchart showing a flow of DES encryption processing. The DES encryption processing is constituted by processes of from a first stage to a 16th stage. First, a 64-bit plain text to be encrypted is permuted by initial permutation to generate 32 bits (L₀) on the left and 32 bits (R₀) on the right, which are the first stage input data (S401). The second stage input data, i.e., L₁ and R₁ are obtained from the following equations (1) and (2):
L₁=R₀ (1)
R₁=L₀⊕F(R₀,K₁). (2)

K₁ is a key generated from a 64-bit common key. The 64-bit common key is converted to 56 bits by contraction permutation (Permuted Choice 1: hereinafter, “PC1 permutation”) to generate 28 bits (C₀) on the left and 28 bits (D₀) on the right (S402). C₀ and D₀ are rotationally shifted left to generate C₁ and D₁ (S403, S404). By converting C₁ and D₁ to 48 bits with contraction permutation (Permuted Choice 2: hereinafter, “PC2 permutation”), K₁ is obtained (S405). By rotationally left shifting C₁ and D₁ and performing the PC2 permutation, Keys K₂ to K₁₆ can be generated, which are used in the second and later stages.

L₁ and R₁ obtained in this way are the second stage input data and the process is repeatedly performed until the 16th stage. That is, Lₙ and Rₙ are obtained from the following equations (3) and (4).
Lₙ=Rₙ₋₁ (3)
Rₙ=Lₙ₋₁⊕F(Rₙ₋₁,Kₙ₋₁) (4)

By performing inverse initial permutation for the 16th stage output data, i.e., L₁₆ and R₁₆, an encrypted text can be obtained, which is the plain text encrypted (S406).

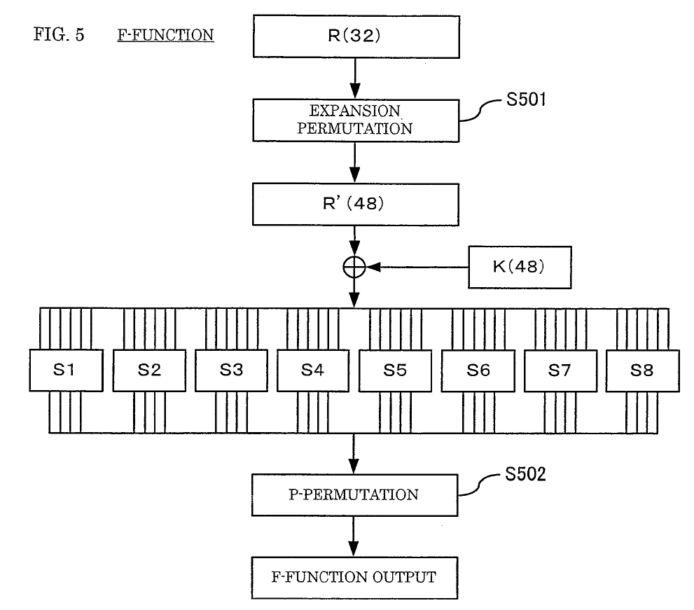

FIG. 5 is a diagram showing a flow of processing of an F-function (F(R, K)). First, 32-bit data R is converted by expansion permutation to 48 bits to generate R′ (S501). After dividing 48-bit data that is obtained by taking exclusive OR of R′ and a 48-bit key K into 6-bit parts, the 6-bit parts are input into S-BOXes S1 to S8. The F-function's output data is data produced by permutation of 32-bit data constituted by groups of 4 bits output from each S-BOX (hereinafter, “P-permutation”) (S502).

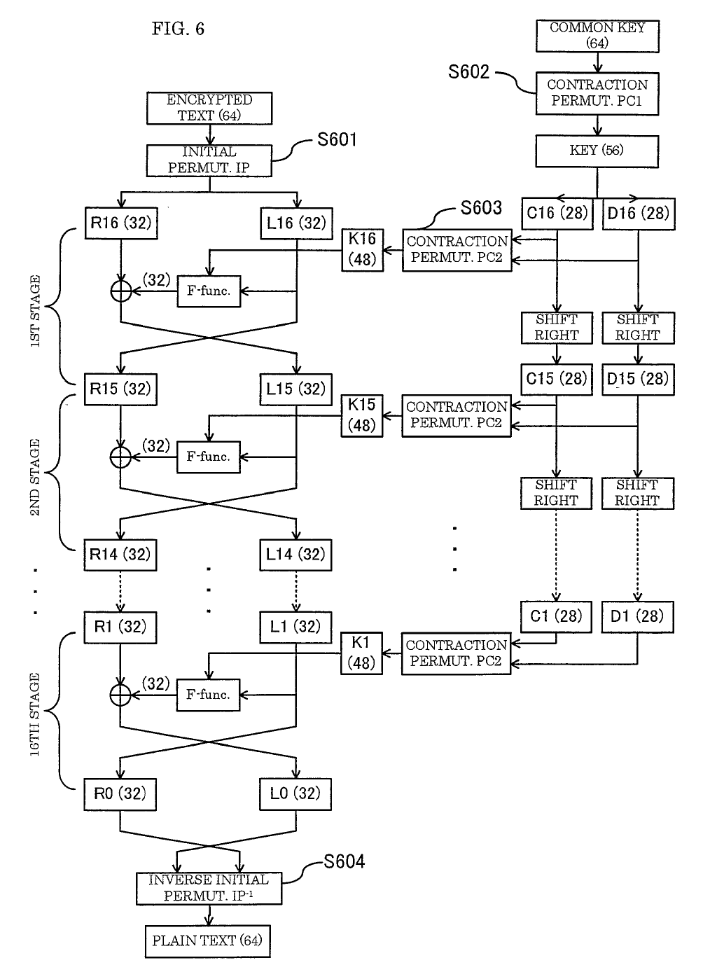

FIG. 6 is a flowchart showing a flow of DES decryption process. The DES decryption process is constituted by processes of from a first stage to a 16th stage as is the case with the encryption process. First, a 64-bit encrypted text to be decrypted is permuted by initial permutation to generate 32 bits (R₁₆) on the left and 32 bits (L₁₆) on the right, which are the first stage input data (S601). The second stage input data, i.e., R₁₅ and L₁₅ are obtained from the following equations (5) and (6).
R₁₅=L₁₆ (5)
L₁₅=R₁₆⊕F(L₁₆,K₁₆) (6)

K₁₆ is a key generated from a 64-bit common key. The 64-bit common key is converted to 56 bits by the PC1 permutation to generate 28 bits (C₁₆) on the left and 28 bits (D₁₆) on the right (S602). By converting C₁₆ and D₁₆ to 48 bits with the PC2 permutation, K₁₆ is obtained (S603). By rotationally right shifting C₁₆ and D₁₆ and performing the PC2 permutation, keys K₁₅ to K₁ can be generated, which are used in the second and later stages.

R₁₅ and L₁₅ obtained in this way are the second stage input data and the process is repeatedly performed until the 16th stage. That is, Rₙ and Lₙ are obtained from the following equations (7) and (8).
Rₙ₋₁=Lₙ (7)
Lₙ₋₁=Rₙ⊕F(Lₙ,Kₙ) (8)

By performing the inverse initial permutation on the 16th stage output data, i.e., R₀ and L₀, a plain text can be obtained, which is the encrypted text decrypted (S604). It is noted that Lₙ, Rₙ, Cₙ, Dₙ, and Kₙ in the decryption process are the same as Lₙ, Rₙ, Cₙ, Dₙ, and Kₙ in the encryption process, and that C₀=C₁₆ and D₀=D₁₆.

==Configuration of Encryption Processing Circuit==

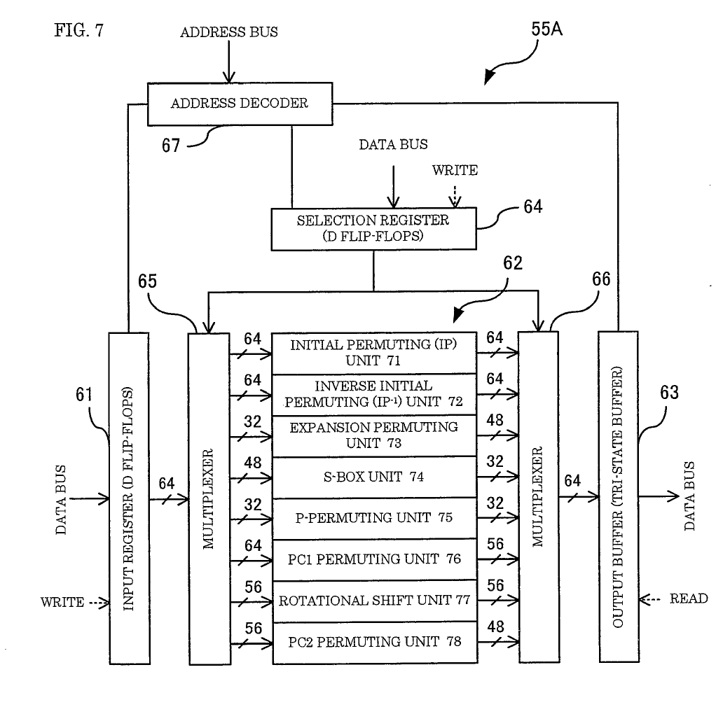

In the implementation, the permutation/substitution process in the encryption and decryption processes described in FIGS. 4 to 6 is achieved with the use of the encryption processing circuits 55A, 55B. Since the encryption processing circuit 55A and the encryption processing circuit 55B has the same configuration, the encryption processing circuit 55A will hereinafter be described. FIG. 7 is a diagram showing the configuration of the encryption processing circuit 55A. The encryption processing circuit 55A is provided with an input register (data input unit) 61, a permuting/substituting unit 62, an output buffer (data output unit) 63, a selection register 64, multiplexers 65, 66, and an address decoder 67.

The input register 61 is a 64-bit register constituted by a plurality of D-type flip-flops (hereinafter, “D-FFs”); the input terminal D of each D-FF is connected to a data bus of the bus 57A; and the output terminal Q (output port) of each D-FF is connected to the permuting/substituting unit 62 via the multiplexer 65. A write signal(WRITE) is input to the clock input terminals of the D-FFs constituting the input register 61. For example, if the data bus is 8-bits wide, the input register 61 may be constituted by eight 8-bit registers.

The permuting/substituting unit 62 is provided with eight modules, i.e., an initial permuting unit 71, an inverse initial permuting unit 72, an expansion permuting unit 73, an S-BOX unit 74, a P-permuting unit 75, a PC1 permuting unit 76, a rotational shift unit 77, and a PC2 permuting unit 78. Each module 71 to 78 of the permuting/substituting unit 62 performs the permutation or substitution process on data input from the input register 61 and outputs to the output buffer 63 via the multiplexer 66.

The S-BOX unit 74 corresponds to the substituting unit of the present invention and other units 71, 72, 73, 75, 76, 77, 78 correspond to the permuting unit of the present invention The selection register 64, the multiplexer 65, and the multiplexer 66 correspond to the selecting unit of the present invention.

The output buffer 63 is a 64-bit tri-state buffer; a 64-bit input (input port) thereof is connected to the permuting/substituting unit 62 via the multiplexer 66; its output is connected to the data bus of the bus 57A. For example, if the data bus is 8-bits wide, the output register 63 may be constituted by eight 8-bit tri-state buffers.

The selection register 64 comprises a plurality of D-FFs and, for example, an 8-bit register; the input terminal D of each D-FF is connected to the data bus of the bus 57A; and the output terminal Q of each D-FF is connected to the multiplexers 65, 66. The write signal (WRITE) is input to the clock input terminal of the D-FFs constituting the selection register 64. Into the selection register 64, selection data is written, which indicates which module is to be selected of the permuting/substituting unit 62. The multiplexer 65 outputs data from the input register 61 to the module designated based on the selection data output from the selection register 64. The multiplexer 66 outputs data from the designated module to the output buffer 63 based on the selection data output from the selection register 64.

The address decoder 67 is connected to an address bus of the bus 57A and selects a circuit corresponding to an address specified by the address bus. In the implementation, the write address of the input register 61 is the same as the read address of the output buffer 63.

Description will be made of a flow of performing the permutation or substitution process with the use of the encryption processing circuit 55A in the data processing circuit 13. The CPU 51A outputs the address of the selection register 64 to the address bus, selection data indicating a desired module of the permuting/substituting unit 62 to the data bus, and outputs the write signal (WRITE) to write the selection data to the selection register. The CPU 51A then outputs the address of the input register 61, the input data of the permutation or substitution process to the data bus, and outputs the write signal (WRITE) to write the input data to the input register 61. Thereby, the data input to the input register 61 are input to the desired module via the multiplexer 65 and the result of the permutation or substitution process is output to the output buffer 63 via the multiplexer 66.

The CPU 51A outputs the address of the output buffer that is the same address as the input register 61 to the address bus and inputs the read signal (READ) to the output buffer 63. By this means, the input data on which the permutation or substitution process has been performed is output from the output buffer 63 to the data bus. In this way, the CPU 51A can perform the permutation or substitution process only by writing data into the input register 61 and reading data from the output buffer 63.

==Configuration of Permuting/Substituting Unit==

Description will be made of the configuration of each module 71 to 78 of the permuting/substituting unit 62.

(1) Initial Permutation

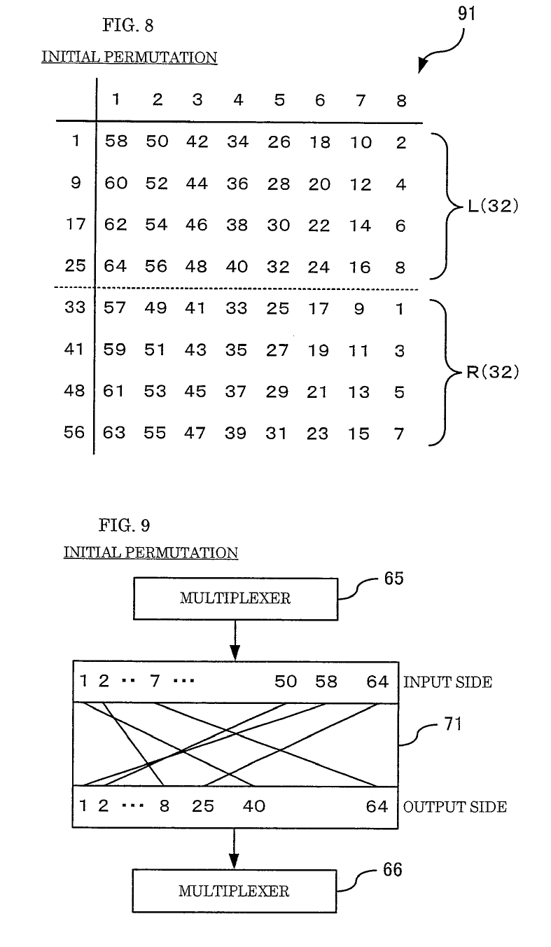

FIG. 8 is a diagram showing a per-bit correspondence rule 91 in the initial permutation. The correspondence rule 91 shows correspondence of each bit between the 64-bit input data and the 64-bit output data, such as a 58th bit of the 64-bit input data input to the initial permuting unit 71 being a first bit of the output data and a 50th bit of the input data being a second bit of the output data.

FIG. 9 is a diagram showing the configuration of the initial permuting unit 71. As shown in the figure, the input side and the output side of the initial permuting unit 71 are connected according to the correspondence rule 91. For example, the 58th bit of the input side is connected to be the first bit of the output side and the 50th bit of the input side is connected to be the second bit of the output side. That is, the initial permuting unit 71 connects the output terminals Q of the input register 61 and the input terminals of the output buffer 63 according to the correspondence rule 91 through the multiplexers 65, 66.

(2) Inverse Initial Permutation

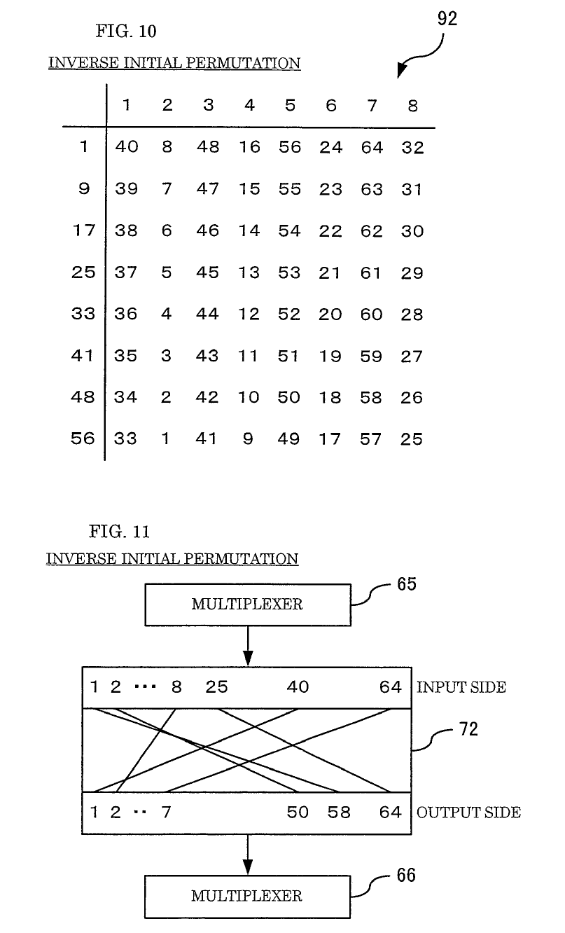

FIG. 10 is a diagram showing a per-bit correspondence rule 92 in the inverse initial permutation. The correspondence rule 92 shows correspondence of each bit between the 64-bit input data and the 64-bit output data, such as a 40th bit of the 64-bit input data input to the inverse initial permuting unit 72 being a first bit of the output data and an eighth bit of the input data being a second bit of the output data.

FIG. 11 is a diagram showing the configuration of the inverse initial permuting unit 72. As shown in the figure, the input side and the output side of the inverse initial permuting unit 72 are connected according to the correspondence rule 92. For example, the 40th bit of the input side is connected to be the first bit of the output side and the eighth bit of the input side is connected to be the second bit of the output side. Therefore, the inverse initial permuting unit 72 connects the output terminals Q of the input register 61 and the input terminals of the output buffer 63 according to the correspondence rule 92 through the multiplexers 65, 66.

(3) Expansion Permutation

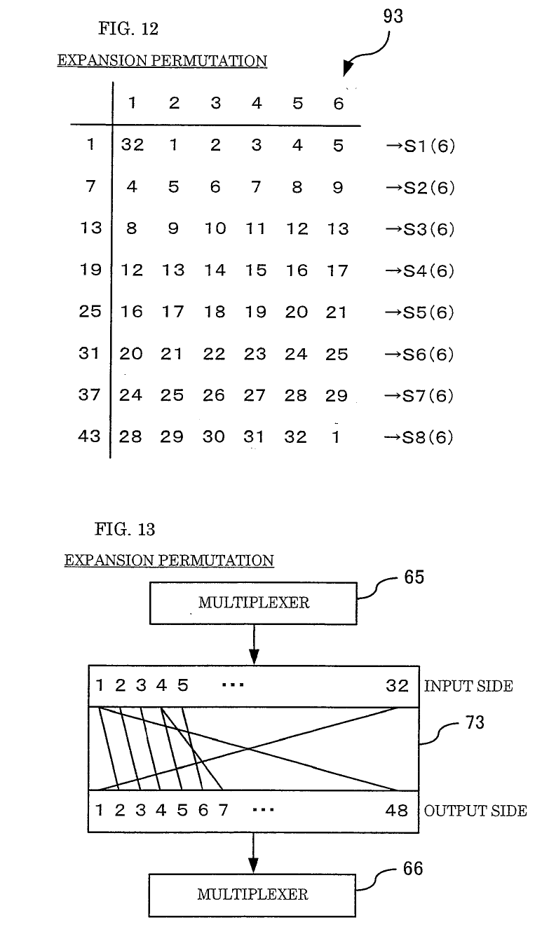

FIG. 12 is a diagram showing a per-bit correspondence rule 93 in the expansion permutation. The correspondence rule 93 shows correspondence of each bit between the 32-bit input data and the 48-bit output data, such as a 32nd bit of the 32-bit input data input to the expansion permuting unit 73 being a first bit of the output data and a first bit of the input data being a second bit of the output data. In the expansion permutation, since the 32-bit input data is expanded into the 48-bit output data, 16 bits of the input data are each output to two bits of the output data. For example, the first bit of the input data is output to two bits, the second bit and 48th bit of the output data.

FIG. 13 is a diagram showing the configuration of the expansion permuting unit 73. As shown in the figure, the input side and the output side of the expansion permuting unit 73 are connected according to the correspondence rule 93. For example, the 32nd bit of the input side is connected to be the first bit of the output side and the first bit of the input side is connected to be the second bit of the output side. That is, the expansion permuting unit 73 connects the output terminals Q of the input register 61 and the input terminals of the output buffer 63 according to the correspondence rule 93 through the multiplexers 65, 66.

(4) S-BOX

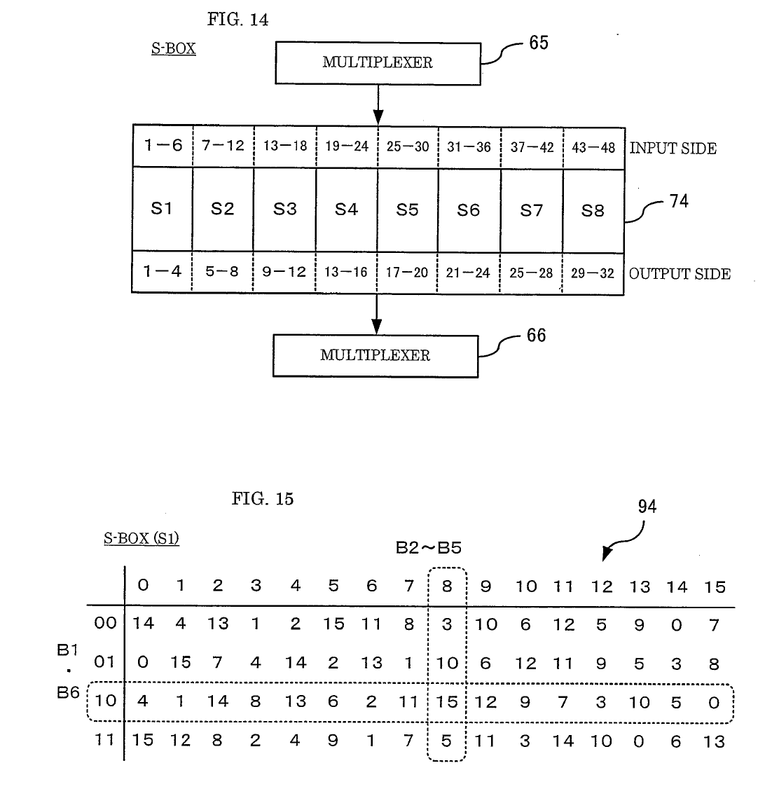

FIG. 14 is a diagram showing the configuration of the S-BOX unit 74. As shown in the figure, the S-BOX unit 74 is constituted by Sl to S8 and 48-bit input data is divided starting from its head into 6-bit data groups and input to S1 to S8. For example, in S1, 6-bit input data is converted into four bits according to a correspondence rule, which is output. Similarly, in S2 to S8, 6-bit input data is converted into four bits according to a respective correspondence rule, which is output.

FIG. 15 is a diagram showing a correspondence rule 94 of the S-BOX (S1). In this correspondence rule 94, a first bit and a sixth bit (B1, B6) of the 6-bit input data input to S1 designates a row; a second bit to a fifth bit (B2 to B5) of the input data designates a column, and data at the crossover point of them is taken as output data. For example, assume that input data of “110000” is input to S1. In this case, (B1, B6) is “10” and thus a third line is selected. (B2 to B5) is “1000”, eight in decimal, and thus the eighth column is selected. Therefore, data of “1111” is output, which is a binary representation of a decimal number of “15” located at the eighth column of the third row. Likewise, a correspondence rule is defined for S2 to S8.

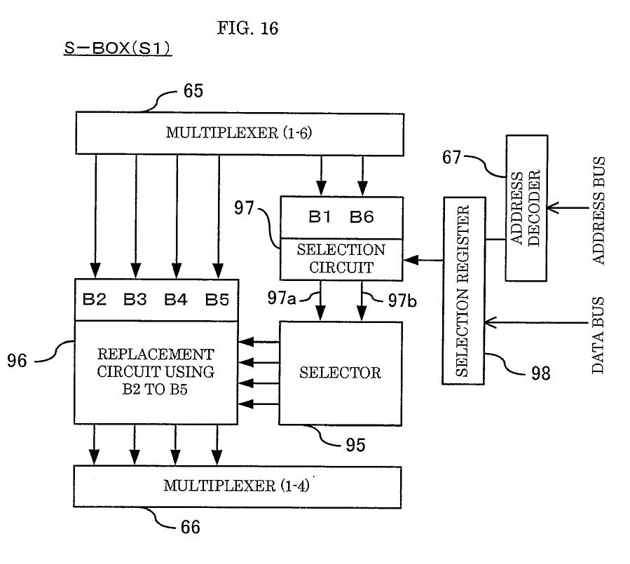

FIG. 16 is a diagram showing the configuration of S1 of the S-BOX unit 74. As shown in the figure, S1 is provided with a selector 95, a replacement circuit 96, and a selection circuit 97. A selection register 98 used by S1 to S8 in common is also provided. The selector 95 and the replacement circuit 96 correspond to the substitution circuit of the present invention.

Into the selector 95, B1 and B6 are input via the selection circuit 97 and, in accordance with the input, the selector 95 outputs to the replacement circuit 96 a signal indicating which row of the correspondence rule 94 to select. The replacement circuit 96 has a logical circuit configured to convert B2 to B5 to values in a corresponding column of the correspondence rule 94, and B2 to B5 is converted to a value designated by the signal from the selector 95 and outputted.

The selection register 98 is, for example, an 8-bit register constituted by a plurality of D-FFs; the input terminal D of each D-FF is connected to the data bus of the bus 57A; and the output terminal Q of each D-FF is connected to the selection circuit 97. The selection circuit 97 can permute B1 and B6 output to the selector 95 in accordance with the selection data output from the selection register 98. For example, if the selection data “0” is output from the selection register 98, the selection circuit 97 outputs B1 as a first bit 97a and outputs B6 as a second bit 97b. If the selection data “1” is output from the selection register 98, the selection circuit 97 outputs B6 as the first bit 97a and outputs B1 as the second bit 97b.

In the case of the input data of “110000” described above, if the selection data of “1” is output from the selection register 98, the data inputted from the selection circuit 97 to the selector 95 is “01”. Hence, the second row is selected and data of “1010” is output, which is a binary representation of a decimal number of “10” located at the eighth column of the second row. In this way, by changing the selection data written into the selection register 98, the correspondence rule 94 of S1 can be changed.

S2 to S8 are configured similarly to S1. That is, the S-BOX unit constituted by S1 to S8 can be said to be a logical circuit that converts the input data output in parallel from the output terminals Q of the input register 61 according to the correspondence rules of S1 to S8 and outputs the converted data to the input of the output buffer 63 via the multiplexers 65, 66.

Although two bits, i.e., the most significant bit and the least significant bit are permuted by the selection circuit 97 and are input to the selector 95 and the remaining four bits are input to the replacement circuit 96 in the implementation, the S-BOX unit 74 is not limited in configuration thereto, but need only permute six bits (B1 to B6) input thereto according to the selection data and convert the permuted data into four bits according to a correspondence rule.

(5) P-Permutation

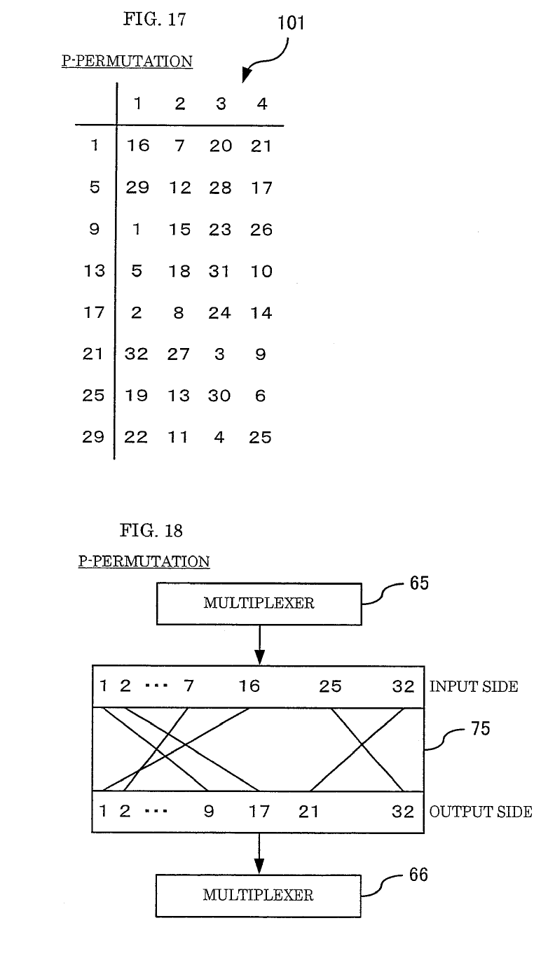

FIG. 17 is a diagram showing a per-bit correspondence rule 101 in the P-permutation. The correspondence rule 101 shows correspondence of each bit between the 32-bit input data and the 32-bit output data, such as a 16th bit of the 32-bit input data input to the P-permuting unit 75 being a first bit of the output data and a seventh bit of the input data being a second bit of the output data.

FIG. 18 is a diagram showing the configuration of the P-permuting unit 75. As shown in the figure, the input side and the output side of the P-permuting unit 75 are connected according to the correspondence rule 101. For example, the 16th bit of the input side is connected to be the first bit of the output side and the seventh bit of the input side is connected to be the second bit of the output side. That is, the P-permuting unit 75 connects the output terminals Q of the input register 61 and the input of the output buffer 63 according to the correspondence rule 101 through the multiplexers 65, 66.

(6) PC1 Permutation

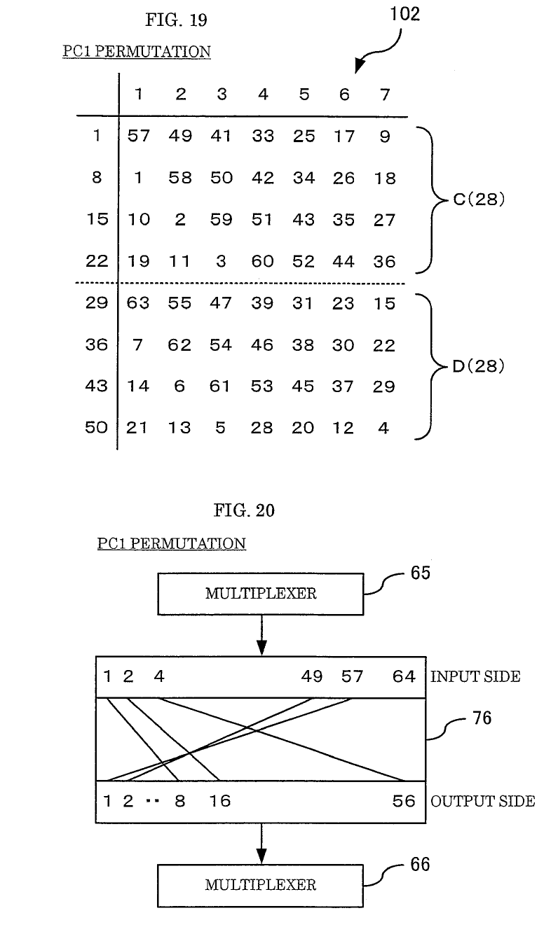

FIG. 19 is a diagram showing a per-bit correspondence rule 102 in the PC1 permutation. The correspondence rule 102 shows correspondence of each bit between the 64-bit input data and the 56-bit output data, such as a 57th bit of the 64-bit input data input to the PC1 permuting unit 76 being a first bit of the output data and a 49th bit of the input data being a second bit of the output data. Since the 64-bit input data is contracted into the 56-bit output data in the PC1 permutation, eight bits of the input data are not output.

FIG. 20 is a diagram showing the configuration of the PC1 permuting unit 76. As shown in the figure, the input side and the output side of the PC1 permuting unit 76 are connected according to the correspondence rule 102. For example, the 57th bit of the input side is connected to be the first bit of the output side and the 49th bit of the input side is connected to be the second bit of the output side. That is, the PC1 permuting unit 76 connects the output terminals Q of the input register 61 and the input of the output buffer 63 according to the correspondence rule 102 through the multiplexers 65, 66.

(7) Rotational Shift

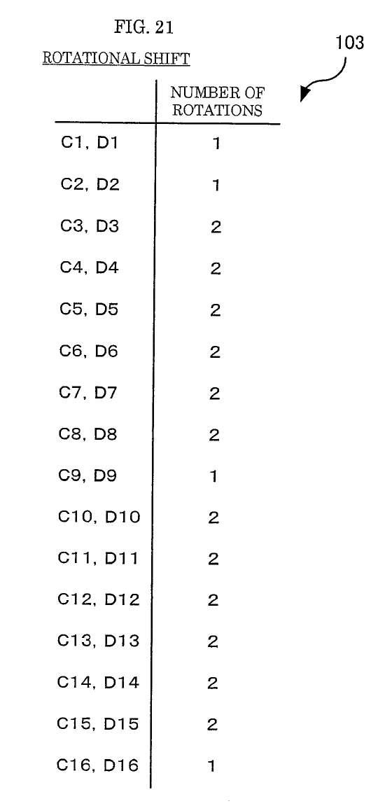

FIG. 21 is a diagram showing a correspondence rule 103 between the input data and the output data in the rotational shift. The correspondence rule 103 describes that 28-bit C₁ and 28-bit D₁ are obtained by rotationally left shifting 28-bit C₀ and 28-bit D₀ by one bit, that C₂ and D₂ are obtained by rotationally left shifting C₁ and D₁ by one bit, and that C₃ and D₃ are obtained by rotationally left shifting C₂ and D₂ by two bits. As such, the correspondence rule 103 describes the number of rotations for C₁ to C₁₆ and D₁ to D₁₆. Note that in the process of rotational left shift, each bit of the input data is corresponding one-to-one to a bit of the output data, and it can be said that the correspondence rule is a per-bit one as is the case with the other permutation processes.

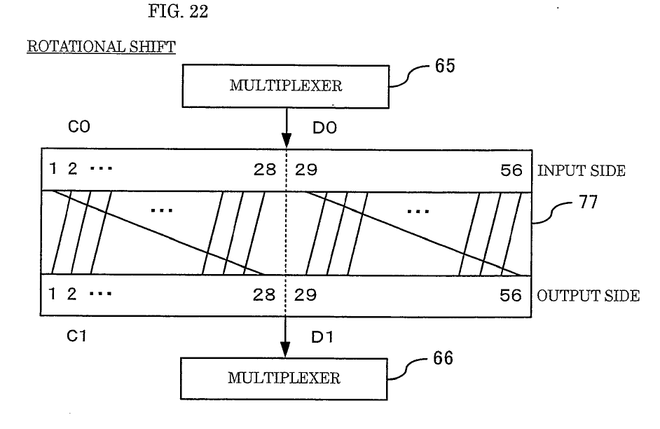

FIG. 22 is a diagram showing the configuration of the rotational shift unit 77. The figure shows a portion that generates C₁ and D₁ from C₀ and D₀ of the rotational shift unit 77, and connection is made such that each of C₀ and D₀ on the input side is rotationally shifted left by one bit and is output to the output side as C₁ and D₁. The portions that generate C₂ to C₁₆ and D₂ to D₁₆ from C₀ and D₀ are similarly configured. That is, the rotational shift unit 77 connects the output terminals Q of the input register 61 and the input of the output buffer 63 according to the correspondence rule 103 through the multiplexers 65, 66.

Although the rotational shift unit 77, which generates C₁ to C₁₆ and D₁ to D₁₆, is configured with separate circuits, for example, a circuit to generate C₁ and D₁, a circuit to generate C₂ and D₂, etc., these circuits can be configured to be combined. In other words, the rotational shift unit 77 can generate C₁ to C₁₆ and D₁ to D₁₆ all together from C₀ and D₀ output from the input register 61, which are output to the output buffer 63. In this case, the output buffer 63 must have a capacity equal to or greater than 112 bytes, 16 times 56 bits (7 byte). Since generating C₁ to C₁₆ and D₁ to D₁₆ all together, the rotational shift for generating the keys K₁ to K₁₆ can be performed by one process. Thus, the processing speed of the encryption and decryption can be improved.

(8) PC2 Permutation

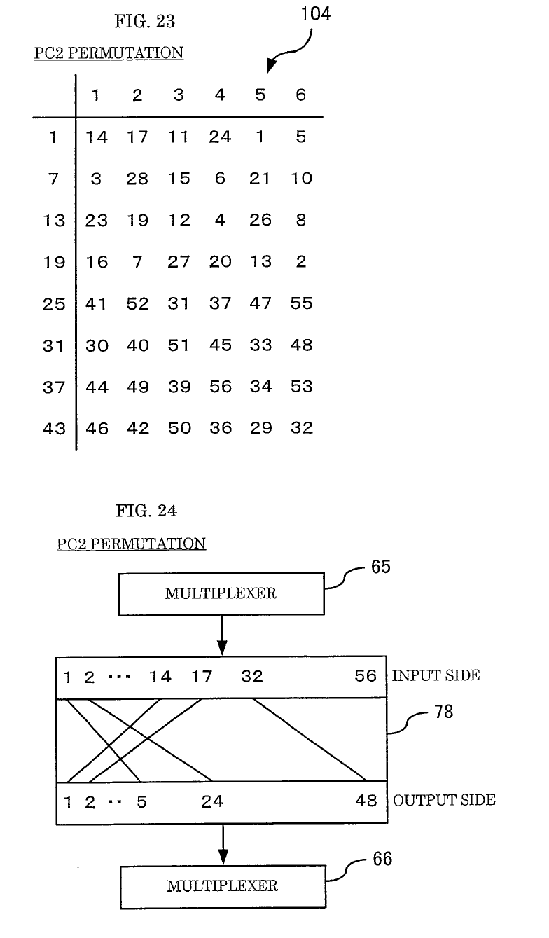

FIG. 23 is a diagram showing a per-bit correspondence rule 104 in the PC2 permutation. The correspondence rule 104 shows correspondence of each bit between the 56-bit input data and the 48-bit output data, such as a 14th bit of the 56-bit input data input to the PC2 permuting unit 78 being a first bit of the output data and a 17th bit of the input data being a second bit of the output data. Since the 56-bit input data is contracted into the 48-bit output data in the PC2 permutation, eight bits of the input data are not output.

FIG. 24 is a diagram showing the configuration of the PC2 permuting unit 78. As shown in the figure, the input side and the output side of the PC2 permuting unit 78 are connected according to the correspondence rule 104. For example,the 14th bit of the input side is connected to be the first bit of the output side and the 17th bit of the input side is connected to be the second bit of the output side. That is, the PC2 permuting unit 78 connects the output terminals Q of the input register 61 and the input of the output buffer 63 according to the correspondence rule 104 through the multiplexers 65, 66.

As above, description has been made of the keyless entry system 1 with the encryption processing circuits 55A, 55B applied according to one implementation of the present invention. As described above, the encryption processing circuits 55A, 55B perform the permutation process of the DES, which is a common key block encryption system, and only by writing input data to be permuted into the input register 61, the permuted data can be obtained via the output buffer 63 from the permuting/substituting unit 62 connected according to the correspondence rule. That is, the encryption processing circuits 55A, 55B can perform permutation without performing processes such as referring to a correspondence table by software and thus perform the encryption and decryption with low power consumption and at high speed.

The encryption processing circuit 55A, 55B is provided with the initial permuting unit 71, the inverse initial permuting unit 72, the expansion permuting unit 73, the P-permuting unit 75, the PC1 permuting unit 76, the rotational shift unit 77, and the PC2 permuting unit 78, which execute the DES permutation processes, and can perform the permutation processes by the units with low power consumption and at high speed.

In the encryption processing circuit 55A, 55B, the input register 61 is shared by the modules 71, 72, 73, 75, 76, 77, 78 that perform the permutation processes, and the data is input to a desired module by the selection register 64 and the multiplexer 65. By sharing the input register 61 as such, the number of components can be reduced and the power consumption of the entire circuitry can be reduced as compared to the case of an input register being provided in each module.

The encryption processing circuit 55A, 55B is provided with the S-BOX unit 74 that performs the S-BOX processing, which is the DES substitution processing, and only by writing the input data to be substituted into the input register 61, the substituted data can be obtained according to the correspondence rule. That is, the encryption processing circuits 55A, 55B can perform substitution without performing processes such as referring to a correspondence table by software and thus perform the encryption and decryption with low power consumption and at high speed.

Although the encryption processing circuit 55A, 55B of the implementation is provided with a plurality of modules 71 to 78 that perform permutation or substitution and the module to be used is switched with the use of the selection register 64 and the multiplexers 65, 66, the modules 71 to 78 may be configured separately. For example, an encryption processing circuit can be configured to perform the initial permutation only.

In the encryption processing circuits 55A, 55B, the multiplexer 65 is used as a circuit that sorts the output data from the input register 61 for the permuting/substituting unit 62. Other than the multiplexer 65, a tri-state buffer can be used as a circuit that sorts data. However, generally, the multiplexer has a shorter time than the tri-state buffer to output target data after receiving an output instruction. Therefore, by using the multiplexer 65 that operates faster than the tri-state buffer in the encryption processing circuits 55A, 55B, the processing speed of the encryption and decryption can be improved.

In the encryption processing circuits 55A, 55B, the data input unit is realized by the input register 61 constituted by a plurality of D-FFs, and the data output unit is realized by the output buffer 63 constituted by the tri-state buffer. Alternatively, a memory, etc., to store written data can also be used as the data input unit. However, if a memory is used, an operation is needed to read out written data to a module of the permuting/substituting unit 62. With the configuration of the encryption processing circuits 55A, 55B of the implementation, when data is written into the input register 61, permuted or substituted data is input to the output buffer 63 at the same time and the data can be read out from the output buffer 63. Therefore, the number of clocks needed in the permutation/substitution processes is reduced and the encryption and decryption can be performed with low power consumption and at high speed.

In the encryption processing circuits 55A, 55B, the write address of the input register 61 is the same as the read address of the output buffer 63. Therefore, to perform the permutation or substitution, it need only be performed to write data into the address and read data from that address. Hence, the program does not have to perform processing such as address conversion and the number of processing steps can be reduced. Therefore, in the encryption and decryption processes, power consumption can be reduced and processing speed can be improved.

By applying the encryption processing circuits 55A, 55B with the reduced power consumption and the improved processing speed as above to the keyless entry system 1, the consumption of the battery 11 of the child device 2 and the consumption of the battery 25 of the parent device 3 can be controlled. Since the encryption and decryption processes are performed at high speed, the response to operations such as locking/releasing can be improved.

The S-BOX unit 74 of the encryption processing circuits 55A, 55B converts according to the predetermined correspondence rule data obtained by permuting the 6-bit data input to each S-BOX of S1 to S8 according to the selection data output from the selection register 98 and outputs. In other words, in the encryption processing circuits 55A, 55B, the substitution can be performed without processing by software and the encryption and decryption can be performed with low power consumption and at high speed. Although a method has been proposed for performing substitution processing, etc., of the common key block encryption system by hardware in Japanese Patent Application Laid-Open Publication No. 2004-178507, correspondence rules between input data and output data are fixed in configuration. Therefore, with such a configuration, if the correspondence rule of the substitution process has been analyzed with a differential attack, a linear attack, etc., the correspondence rule cannot be changed unless the hardware is modified, and thus the security is not sufficient. On the other hand, in the S-BOX unit 74 of the encryption processing circuits 55A, 55B, by rewriting the selection data stored in the selection register, the correspondence rule between the input data and the output data can be changed without modifying the hardware, and thus the security can be enhanced. Especially, in the S-BOX unit 74 of the encryption processing circuits 55A, 55B, by permuting the most significant bit and the least significant bit of the 6-bit input data according to the selection data, for example, the row being selected in the correspondence rule 94 of S1 can be changed without modifying the hardware, thus enhancing the security.

Although description in the implementation has been made of an example where the encryption processing circuit of the present invention is applied to the DES, which is one of the common key block encryption systems, the common key block encryption system is not limited to the DES, but also in the common key block encryption system such as the triple DES or the AES (Advanced Encryption Standard), with the same configuration, the correspondence rule between input data and output data in the substitution processing can be configured to be changed without modifying the hardware, thus enhancing the security.

Although the keyless entry system 1 has been described as an example application of the encryption processing circuits 55A, 55B in the implementation, they can be applied not only to the keyless entry system 1 but also to various systems requiring the data encryption such as an automatic ticket gate system using IC cards and an entering/leaving management system.

The above implementations are merely for the purpose of facilitating the understanding of the present invention, rather than construing the present invention in a limited manner. The present invention can variously be modified and altered without departing from the spirit thereof and the present invention encompasses equivalents thereof.

What is claimed is:

1. An encryption processing circuit which performs a permutation process of a common key block encryption system that permutes input data of plural bits according to a per-bit correspondence rule and outputs the processed data, comprising:
a data input unit that receives the input data of plural bits, the data input unit having an output port that outputs the received input data of plural bits in parallel;
a data output unit that has an input port to which data of plural bits is input in parallel, the data output unit outputting the data of plural bits inputted to the input port; and
a permuting unit that connects the output port and the input port according to the per-bit correspondence rule.

2. The encryption processing circuit of claim 1,
wherein the common key block encryption system is a DES,
wherein the input data is input data in initial permutation, and
wherein the per-bit correspondence rule is a per-bit correspondence rule for the initial permutation.

3. The encryption processing circuit of claim 1,
wherein the common key block encryption system is a DES,
wherein the input data is input data in inverse initial permutation, and
wherein the per-bit correspondence rule is a per-bit correspondence rule for the inverse initial permutation.

4. The encryption processing circuit of claim 1,
wherein the common key block encryption system is a DES,
wherein the input data is input data in expansion permutation of an F-function, and
wherein the per-bit correspondence rule is a per-bit correspondence rule for the expansion permutation of the F-function.

5. The encryption processing circuit of claim 1,
wherein the common key block encryption system is a DES,
wherein the input data is data output from an S-BOX of an F-function, and
wherein the per-bit correspondence rule is a per-bit correspondence rule for permutation of the F-function to which the input data is input.

6. The encryption processing circuit of claim 1,
wherein the common key block encryption system is a DES,
wherein the input data is a common key to be input into contraction permutation (Permuted Choice 1), and
wherein the per-bit correspondence rule is a per-bit correspondence rule for the contraction permutation.

7. The encryption processing circuit of claim 1,
wherein the common key block encryption system is a DES,
wherein the input data is input data in contraction permutation (Permuted Choice 2), and
wherein the per-bit correspondence rule is a per-bit correspondence rule for the contraction permutation.

8. The encryption processing circuit of claim 1,
wherein the common key block encryption system is a DES,
wherein the input data is data obtained by permuting a common key by contraction permutation (Permuted Choice 1), and
wherein the per-bit correspondence rule is a per-bit correspondence rule between the input data and data to be input to contraction permutation (Permuted Choice 2).

9. The encryption processing circuit of claim 1, further comprising:
a plurality of the permuting units having per-bit different correspondence rules; and
a selecting unit that receives selection data indicating which one of the plurality of the permuting units is to be used and inputs the input data output from the data input unit into the permuting unit designated by the selection data.

10. The encryption processing circuit of claim 9,
wherein the common key block encryption system is a DES, and
wherein each of the per-bit correspondence rules of the plurality of the permuting units is one of:
a per-bit correspondence rule for initial permutation;
a per-bit correspondence rule for inverse initial permutation;
a per-bit correspondence rule for expansion permutation of an F-function;
a per-bit correspondence rule for permutation to which data output from an S-BOX of the F-function is input;
a per-bit correspondence rule for contraction permutation (Permuted Choice 1);
a per-bit correspondence rule for contraction permutation (Permuted Choice 2); and
a per-bit correspondence rule between data output from the contraction permutation (Permuted Choice 1) and data to be input to the contraction permutation (Permuted Choice 2).

11. The encryption processing circuit of claim 9, further comprising a substituting unit that is a logical circuit which converts the input data of plural bits output in parallel from the data input unit according to a correspondence rule and outputs to the input port of the data output unit in parallel,
wherein the selection data is data indicating which one of the plurality of the permuting units and the substituting unit is to be used, and
wherein the selecting unit inputs the input data output from the data input unit to the permuting unit or the substituting unit designated by the selection data.

12. The encryption processing circuit of claim 11,
wherein the common key block encryption system is a DES,
wherein each of the per-bit correspondence rules of the plurality of the permuting units is one of:
a per-bit correspondence rule for initial permutation;
a per-bit correspondence rule for inverse initial permutation;
a per-bit correspondence rule for expansion permutation of an F-function;
a per-bit correspondence rule for permutation to which data output from an S-BOX of the F-function is input;
a per-bit correspondence rule for contraction permutation (Permuted Choice 1);
a per-bit correspondence rule for contraction permutation (Permuted Choice 2); and
a per-bit correspondence rule between data output from the contraction permutation (Permuted Choice 1) and data to be input to the contraction permutation (Permuted Choice 2), and
wherein the correspondence rule of the substituting unit is a correspondence rule between data input to the S-BOX and data to be output from the S-BOX.

13. The encryption processing circuit of claim 9,
wherein the selecting unit is a multiplexer.

14. An encryption processing circuit which performs a substitution process of a common key block encryption system that converts input data of plural bits according to a correspondence rule and outputs the processed data, comprising:
a data input unit that receives the input data of plural bits, the data input unit having an output port that outputs the received input data of plural bits in parallel;
a substituting unit that is a logical circuit which converts the input data of plural bits output in parallel from the data input unit according to the correspondence rule and outputs; and
a data output unit that has an input port to which data of plural bits output from the substituting unit is input in parallel, the data output unit outputting the data of plural bits input to the input port.

15. The encryption processing circuit of claim 14,
wherein the common key block encryption system is a DES,
wherein the input data is data to be input to an S-BOX of an F-function, and
wherein the correspondence rule is a correspondence rule between the input data and data to be output from the S-BOX.

16. The encryption processing circuit of claim 1,
wherein the data input unit comprises a plurality of D-type flip-flops, and the output port is output terminals of the plurality of D-type flip-flops, and
wherein the data output unit is a tri-state buffer.

17. The encryption processing circuit of claim 1,
wherein a write address of the data input unit is the same as a read address of the data output unit.

18. An encryption processing circuit which performs a substitution process of a common key block encryption system that converts input data of plural bits and outputs the processed data,
wherein the encryption processing circuit is a logical circuit that receives the input data and selection data instructing to permute the input data and permutes the input data according to the selection data and then converts the permuted input data according to a predetermined correspondence rule and outputs.

19. The encryption processing circuit of claim 18,
wherein the common key block encryption system is a DES, and
wherein the predetermined correspondence rule is a correspondence rule between data input to an S-BOX of the DES and data to be output from the S-BOX.

20. The encryption processing circuit of claim 19,
wherein the logical circuit comprises:
a selection circuit that permutes according to the selection data the most significant bit and the least significant bit of the input data of plural bits input to the S-BOX and outputs, and
a substitution circuit that converts according to the predetermined correspondence rule the most significant bit and the least significant bit of the input data of plural bits output from the selection circuit and the other bits of the input data of plural bits than the most significant bit and the least significant bit and outputs.
